(19) United States
(12) Patent Application Publication
(10) Pub. No.: US 2012/0025139 A1
(43) Pub. Date: Feb. 2, 2012

(54) II-III-V COMPOUND SEMICONDUCTOR

(75) Inventors: Peter Neil TAYLOR, Oxford (GB); Jonathan HEFFERNAN, Oxford (GB); Stewart Edward HOOPER, Oxford (GB); Tim Michael SMEETON, Oxford (GB)

(73) Assignee: SHARP KABUSHIKI KAISHA, Osaka (JP)

(21) Appl. No.: 13/187,644

(22) Filed: Jul. 21, 2011

(30) Foreign Application Priority Data
Jul. 28, 2010 (GB) 1012646.4

(51) Int. Cl. C09K 11/54; C01B 21/00

(52) U.S. Cl. 252/301.6 R; 423/351

(57) ABSTRACT

The present application provides a new composition of matter in the form of a new compound semiconductor family of the type group Zn-(II)-III-N, where III denotes one or more elements in Group III of the periodic table and (II) denotes one or more optional further elements in Group II of the periodic table. Members of this family include for example, ZnGaN, ZnInN, ZnInGaN, ZnAlN, ZnAlGaN, ZnAlInN or ZnAlGaInN. This type of compound semiconductor material is not previously known in the prior art.

The composition of the new Zn-(II)-III-N compound semiconductor material can be controlled in order to tailor its band-gap and light emission properties. Efficient light emission in the ultraviolet-visible-infrared wavelength range is demonstrated.

The products of this invention are useful as constituents of optoelectronic devices such as solar cells, light emitting diodes, laser diodes and as a light emitting phosphor material for LEDs and emissive EL displays.

### FIELD OF THE INVENTION

This invention relates to a new composition of matter in the field of inorganic compound semiconductor materials. In particular, a new compound semiconductor family of the type II-III-V—that is a compound semiconductor in which one or more constituents are in Group II of the periodic table, one or more constituents are in Group III of the periodic table and one or more constituents are in Group V of the periodic table—has been fabricated for the first time.

### BACKGROUND OF THE INVENTION

Such materials can be used in a wide range of applications including solar cells, light emitting diodes, emissive EL displays and bio-imaging.

A compound semiconductor is a semiconductor material composed of elements from two or more groups of the periodic table. These elements can form binary (2 elements), ternary (3 elements), quaternary (4 elements) or penternary (5 elements) compounds. The most common families of compound semiconductors are III-V compounds (e.g. GaAs, AlGaAs, GaN, GaInP) and II-VI compounds (e.g. ZnS, CdTe, ZnO). But, numerous other compound semiconductor families have been studied (e.g. I-VII, IV-VI, V-VI, II-V etc). A comprehensive source of the basic data of known inorganic semiconductors is contained in Semiconductors: Data Handbook by Madelung, Springer-Verlag press; 3rd ed. edition (November 2003).

III-V semiconductors are numerous and one of the most interesting classes of III-V semiconductors is the III-nitrides, such as AlN, GaN, InN and their respective alloys. These are used for the manufacture of blue light-emitting diodes, laser diodes and power electronic devices. Nitrides are also chemically inert, are resistant to radiation, and have large breakdown fields, high thermal conductivities and large high-field electron drift mobilities; making them ideal for high-power applications in caustic environments [Neumayer at. al., Chem., Mater., 1996, 8, 25]. The band gaps of aluminium nitride (6.2 eV), gallium nitride (3.5 eV) and Indium nitride (0.7 eV) [Gillan et. al., J. Mater. Chem., 2006, 38, 3774] mean that nitrides span much of the ultraviolet, visible and infrared regions of the electromagnetic spectrum. The fact that alloys of these materials have direct optical band gaps over this range makes these very significant for optical devices.

II-V semiconductor compounds such as ZnN and ZnAs are also known [Paniconi et al. J. Solid State Chem 181 (2008) 158-165] and [Chelluri et al. APL 49 24 (1986) 1665-1667]. But, the addition of a group III element to these binary II-V compounds is not known. Also, III-IV-V semiconductors, for example SiGaAs, have been reported in thin film form [U.S. Pat. No. 4,213,781].

Solid-solution GaN/ZnO nanocrystals have been reported [Han et al. APL. 96, (2010) 183112] and were formed by combining GaN and ZnO nanocrystals as a crystal solid. The ratio of ZnO to GaN was controlled by varying the nitridation time of a GaZnO precursor.

T. Suski et al. propose, in “(GaMg)N new semiconductor grown at high pressure of nitrogen” Journal of Crystal Growth Vol 207, pp27-29 (1999), the synthesis of GaMgN, by high-pressure, high-temperature growth from nitrogen solution in a liquid gallium melt that included magnesium.

JP06-077 605 contains a single reference to a semiconductor element having a “p-ZnGaAs electrode layer”, but contains no details of how to fabricate this. All other references to the electrode layer refer to p-InGaAs.

JP04-152 579 proposes a superlattice avalanche photodiode. The layer structure of the photodiode is described as including a “p-ZnGaAs” film, but no details are given of how to fabricate this.

JP01-239 983 proposes a semiconductor laser fabricated in the AlGaAs system. The structure is doped with zinc to form diffusion regions.

U.S. Pat. No. 4,454,008 proposes a method of forming a junction in a ternary semiconductor alloy and simultaneously passivating the surface, by applying an electric current to induce different rates of migration of different ions towards or away from the surface. Possible compounds are listed, including “HgGaAs”. However, there is no description of how HgGaAs might be fabricated.

JP-7-249821 proposes a semiconductor of the general formula Aₓ Bₓ C_{y} N_{2x+y}, where A denotes a group II element, B denotes a group IV element, C denotes a group III element, and where 0<x≦1 and 0≦y<1. This compound must contain a group IV element, since the mole fraction x of the group IV element (“B”) is non-zero.

U.S. Pat. No. 6,527,858 proposes the fabrication of a ZnO single crystal, by a process in which atomic zinc and oxygen are supplied to a growth chamber, together with atomic nitrogen (as a p-type dopant) and atomic gallium (as an n-type dopant).

### SUMMARY OF THE INVENTION

A first aspect of the present invention provides a semiconductor material having the general formula II-III-N, where II denotes one or more elements in Group II of the periodic table, III denotes one or more elements in Group III of the periodic table, and N denotes nitrogen, wherein the one or more elements in Group II of the periodic table comprises zinc (Zn). That is, the material comprises Zn as a Group II element, and may optionally comprise one or more other Group II elements.

The present invention provides a new composition of matter in the form of a compound semiconductor family of the type group Zn-(II)-III-N, where III denotes one or more elements in Group III of the periodic table and (II) denotes one or more optional further elements in Group II of the periodic table. If the material comprises Zn as the only Group II element its formula may be written as Zn-III-N. A compound semiconductor family of the type Zn-(II)-III-N or Zn-III-N is not known to have been made or studied previously.

As noted above, doping of III-V semiconductors with a group II element (e.g. Mg) or IV element (e.g. Si) is typically used to change its electrical conductivity. However, the tiny amount of group II element typically needed to dope a III-V semiconductor does not lead to the formation of an II-III-V compound [see Pankove et al. J.Appl. Phys. 45, 3, (1974) 1280-1286].

On pages 5 and 6 of the book “Semiconductor Materials” (ISBN-08493-8912-7) Berger lists theoretically conceivable ternary semiconductor compounds and the group II-III-V is included in the lists. However, Berger goes on to list many specific examples of ternary compounds, but no example of any specific II-III-V compound that had been fabricated is given.

In the field of III-V semiconductor nanocrystals, the formation of group ABC semiconductor nanocrystals is mentioned, where A is group II, III or IV, B is group II, III or IV and C is group V or VI [U.S. Pat. No. 7,399,429 B2 paragraph 5]. However, the actual formation of a nanocrystal of a II-III-V compound is neither reported nor even specifically proposed.

As mentioned, solid-solution GaN/ZnO nanocrystals have been reported by Han et al. (above). However the formation of ZnN or ZnGaN nanocrystals was not reported.

Again in the field of III-V nitride semiconductor nanocrystals, UK patent application 0901225.3 describes emissive nitride nanocrystals in which a zinc precursor is used during the nanocrystal synthesis. This application does not show or state that a Zn-III-N compound is formed.

Examples of Zn-(II)-III-N semiconductor compounds include: ZnGaN, ZnInN, ZnInGaN, ZnAlN, ZnAlGaN, ZnAlInN, ZnAlGaInN, MgInN and ZnGaP. A Zn-(II)-III-N compound semiconductor has not been fabricated in the prior art.

To be more specific, a compound semiconductor of the invention will have a formula of the following general form Znₓ₁ (IIaₓ₂IIbₓ₃IIcₓ₄) IIIaₓ₅IIIbₓ₆IIIcₓ₇ N where Zn is zinc, IIa, IIb, IIc . . . are optional constituents and correspond to different group II elements other than Zn, IIIa, IIIb, IIIc . . . correspond to different group III elements, and the numbers x1, x2, x3, x4 . . . give the relative quantities of the elements in the alloy and are set so as to balance the stoichiometry and electrical charge. For convenience however, the numbers x1, x2, x3, x4 . . . will generally be omitted from formulae given herein.

The material may contain at least 1% by volume of Zn. It should be understood that in a Zn-(II)-III-N compound of the invention, the zinc, any other group II elements (if present), the group III element(s) and the nitrogen are each incorporated into the crystal structure of the compound. That in, in a ZnInN or MgInN compound of the invention, for example, the Zn or Mg atoms, the In atoms and the N atoms are all arranged regularly in the ZnInN crystal structure. In contrast, in prior cases where a group II element such as Mg is used as a dopant in a III-V compound, the group II element is present in very small amounts (compared to the amounts of group III element or group V element) and the group II element is not properly incorporated in to the crystal structure of the III-V compound—so that the result is a group III-V compound that contains a small amount of a group II impurity. As a general rule, a Zn-(II)-III-N or Zn-III-N material of the present invention will contain at least 1% by volume of each of the group II, III and V element atoms—whereas, when a group II element is used as a dopant in a III-V compound, the compound will contain much less than 1% of the group II element.

The semiconductor material may comprise, without limitation, any one of the following: ZnGaN; ZnInN; ZnAlN; ZnGaInN.

The semiconductor material may have a single crystal structure, a polycrystalline structure, or an amorphous structure.

The material may be light-emissive.

The semiconductor material may be intentionally doped so as to contain at least one dopant material. This enables either a p-type doped material or an n-doped material to be obtained, depending on the dopant used. Alternatively, the material may not be intentionally doped, and thus remains a semi-insulating material.

The dopant may be selected from the group of: silicon, magnesium, carbon, beryllium, calcium, germanium, tin and lead.

A second aspect of the invention provides a semiconductor nanoparticle comprising a semiconductor material of the first aspect. By a “nanoparticle” is meant a particle having in which at least one dimension is a nanoscale dimension, for example of the order of 1 to 100 nm and more preferably of the order of 1 to 30 nm. In a preferred embodiment a nanoparticle of the invention has three dimensions that are a nanoscale dimension, for example of the order of 1 to 100 nm and more preferably of the order of 1 to 30 nm. A nanoparticle of the invention may have a crystalline or polycrystalline structure and so form a nanocrystal, or it may have an amorphous structure.

A third aspect of the invention provides a semiconductor thin film comprising a semiconductor material of the first aspect.

A fourth aspect of the invention provides a method of making a semiconductor material composed of a Zn-(II)-III-N compound, the method comprising reacting at least one source of zinc, at least one source of a source of a group III element, and at least one source of nitrogen. (If the material comprises one or more other group II elements in addition to zinc, a source of the or each other group II element is also required.)

The method may comprise reacting the at least one source of zinc, the at least one source of a group III element, and the at least one source of nitrogen in a solvent.

The at least one source of zinc may comprise a zinc carboxylate.

It has been found that the use of a carboxylate, for example such as a stearate, as a starting material to provide the zinc of the Zn-(II)-III-N compound may assist in obtaining a light-emissive Zn-(II)-III-N material, in particular obtaining light-emissive nanocrystal.

The at least one source of nitrogen may comprise an amide, for example sodium amide. The use of a carboxylate, for example a stearate, as a source of zinc together with the use of an amide as the source of nitrogen has been found to be particularly advantageous in the formation of nanocrystals of a Zn-(II)-III-N compound, as the stearate is believed to help to solubilise the amide in the reaction mixture to provide a more homogeneous solution, which is expected to allow for more controlled growth of the nanocrystals. The invention is not however limited to use of a carboxylate as the source of the group II element and other sources of the group II element may be used, such as, for example, amines, acetoacetonates, sulfonates, phosphonates, thiocarbamates or thiolates.

A Zn-(II)-III-N or Zn-III-N compound of the invention has potentially many applications. The band gap energy or energy gap of a semiconductor is defined as the minimum room temperature energy gap between the valence band and conduction band of a semiconductor material. It is expected that the present invention will make possible the fabrication of group Zn-(II)-III-N or Zn-III-N semiconductor compounds having an energy gap anywhere in the range from 0.6 eV to 6.2 eV. The desired band gap energy will depend on the intended application of the group Zn-(II)-III-N or Zn-III-N semiconductor compound, but one important application of the invention is expected to be the fabrication of compounds having energy band gaps in the range 0.6 eV to 4.0 eV—this is the range required by a material to absorb almost the entire solar spectrum for use in very high efficiency solar cells.

In more detail, the Zn-(II)-III-N compound semiconductor may comprise a material alloy of:
zinc (a group II element from the periodic table);
optionally, one or more further elements from group II from the periodic table;
one or more group III elements from the periodic table (for example, Ga, In, Al, B, TI); and
nitrogen (a group V elements from the periodic table).

The Zn-(II)-III-N or Zn-III-N semiconductor compound may exist in the form of singular or multiple thin films deposited onto a substrate.

Alternatively, the Zn-(II)-III-N or Zn-III-N semiconductor compound may exist in the form of nanoparticles, for example nanocrystals having nanometre dimensions.

Another important application of the invention is expected to be the fabrication of light-emissive Zn-(II)-III-N or Zn-III-N semiconductor compounds, for example the fabrication of light-emissive Zn-(II)-III-N or Zn-III-N semiconductor nanoparticles or nanocrystals.

By a “light-emissive” material is meant a material that, when illuminated by a suitable exciting light source, emits light. One measure of whether a material is light-emissive is its “photoluminescence quantum yield” (PLQY)—the PLQY of a semiconductor material is the ratio, when the material is illuminated by an exciting light source to cause the material to photoluminesce, of the number of photons emitted by the material to the number of photons absorbed by the material. (It should be noted that the term “photoluminescence quantum yield” should not be confused with the term “photoluminescence quantum efficiency” which is sometimes used in the art. The “photoluminescence quantum efficiency” takes into account the energy of the photons which are absorbed and emitted by a material. In cases where the excitation and emission wavelengths are similar the photoluminescence quantum yield and photoluminescence quantum efficiency will have similar values; however in cases where the excitation wavelength is shorter and hence of higher energy than the emission wavelength the photoluminescence quantum efficiency will be lower than the photoluminescence quantum yield.) For the purposes of this specification, a “light-emissive” material will be taken to be a material with a PLQY of 1% or above.

It has been found that Zn-(II)-III-N or Zn-III-N semiconductor materials of the invention may possesses remarkable luminescent properties particularly in the visible region of the electromagnetic spectrum. As described below, Zn-(II)-III-N or Zn-III-N semiconductor nanocrystals have been fabricated that readily exhibit PLQY values above 10%, and as high as 55% in the case of ZnAlN nanocrystals.

The product of this invention is useful as a constituent of optoelectronic devices such as solar cells, light emitting diodes, laser diodes and as a light emitting phosphor material for LEDs and emissive EL displays.

### BRIEF DESCRIPTION OF THE DRAWINGS

Preferred embodiments of the present invention will be described by way of example with reference to the accompanying figures, in which:

FIG. 1: shows PL emission spectra of a set of zinc gallium nitride in the form of nanocrystals obtained from a single reaction at different times.

FIG. 2: shows the room temperature PL emission spectra of ZnGaN in the form of nanocrystals having gallium: zinc molar ratios of 3:1, 1:1 and 1:3.

FIG. 3: shows the variation in the peak PL emission wavelengths of ZnGaN nanocrystals obtained for different reaction times and using different zinc to gallium ratios.

FIG. 4: shows PL emission spectra of a set of zinc indium nitride in the form of nanocrystals obtained from a single reaction at different times.

FIG. 5: shows the variation in the peak PL emission wavelengths of ZnInN nanocrystals obtained for different reaction times and using different zinc to indium ratios.

FIG. 6: shows PL emission spectra of a set of zinc aluminium nitride in the form of nanocrystals obtained from a single reaction at different times.

FIGS. 7(a) and 7(b) are Transmission Electron Micrographs of ZnAlN nanoparticles obtained by a method of the invention

### DESCRIPTION OF THE PREFERRED EMBODIMENTS

This invention relates to a new semiconducting compound. More specifically it relates to a new semiconductor compound of the general formulae IIₓIII_{y}N_{z} where II is an element, or elements, from group H of the periodic table, III is an element, or elements from group III of the periodic table, the element from group II of the periodic table is zinc (Zn), or one of the elements from group II of the periodic table (if there is more than one) is zinc (Zn), and x, y, z are positive integers which are required to balance the stoichiometry and electronic charge.

In a preferred embodiment, the present Zn-(II)-III-N or Zn-III-N semiconductor material may exist in the form of one or more thin film layers on a substrate.

In another preferred embodiment, the present Zn-(II)-III-N or Zn-III-N semiconductor material may exist in the form of a plurality of nanocrystals.

In another preferred embodiment, the present Zn-(II)-III-N or Zn-III-N semiconductor material may exist in the form of a powder.

In another preferred embodiment, the present Zn-(II)-III-N or Zn-III-N semiconductor material may exist in a form of any shape or size dimensions.

In another preferred embodiment, the present Zn-(II)-III-N or Zn-III-N semiconductor material may exist in the form of a single crystalline material.

In another preferred embodiment, the present Zn-(II)-III-N or Zn-III-N semiconductor material may exist in the form of a polycrystalline material.

In another preferred embodiment, the present Zn-(II)-III-N or Zn-III-N semiconductor material may exist in the form of an amorphous material.

In another preferred embodiment, the present semiconductor material consists of zinc gallium nitride. This material alloy has an energy gap of between 1.0 eV and 3.4 eV, depending on the Zn:Ga ratio, which traverses the visible spectral region.

In another preferred embodiment, the present semiconductor material consists of zinc aluminium gallium indium nitride. This material has an energy gap of between 0.6 eV and 4.0 eV, again depending on the exact composition, that traverses the solar spectral region.

In another preferred embodiment, the present semiconductor material consists of zinc aluminium nitride. This material alloy can yield a wide energy gap of up to 6.2 eV, and this material is therefore suitable for current blocking applications.

In another preferred embodiment, the present semiconductor material consists of zinc indium nitride. This material alloy can yield a small energy gap of 0.6 eV, and this material is therefore suitable for electrical contact applications.

In another preferred embodiment the present semiconductor material can be doped with one or more impurity elements. Examples of impurity elements are silicon, magnesium, carbon, beryllium, calcium, germanium, tin and lead.

In another preferred embodiment the Zn-(II)-III-N or Zn-III-N semiconductor can be implanted with one or more impurity elements.

In another preferred embodiment the Zn-(II)-III-N or Zn-III-N semiconductor can have p-type conductivity.

In another preferred embodiment the Zn-(II)-III-N or Zn-III-N semiconductor can have n-type conductivity.

In another preferred embodiment the Zn-(II)-III-N or Zn-III-N semiconductor can be semi-insulating.

An application of the novel material of the current invention is the use of a Zn-(II)-III-N or Zn-III-N compound semiconductor in a solar cell.

A further application of the novel material of the current invention is the use of a Zn-(II)-III-N or Zn-III-N compound semiconductor in a photovoltaic device.

A further application of the novel material of the current invention is the use of a Zn-(II)-III-N or Zn-III-N compound semiconductor in a light emitting diode.

A further application of the novel material of the current invention is the use of a Zn-(II)-III-N or Zn-III-N compound semiconductor in a light emitting device.

A further application of the novel material of the current invention is the use of a Zn-(II)-III-N or Zn-III-N compound semiconductor in a laser diode device.

A further application of the novel material of the current invention is the use of a Zn-(II)-III-N or Zn-III-N compound semiconductor in a laser

A further application of the novel material of the current invention is the use of a Zn-(II)-III-N or Zn-III-N compound semiconductor in an electronic device.

A further application of the novel material of the current invention is the use of a Zn-(II)-III-N or Zn-III-N compound semiconductor in a transistor device.

A further application of the novel material of the current invention is the use of a Zn-(II)-III-N or Zn-III-N compound semiconductor in a microprocessor device.

A further application of the novel material of the current invention is the use of a Zn-(II)-III-N or Zn-III-N compound semiconductor in an amplifier device.

A further application of the novel material of the current invention is the use of a Zn-(II)-III-N or Zn-III-N compound semiconductor in a power switching device.

A further application of the novel material of the current invention is the use of a Zn-(II)-III-N or Zn-III-N compound semiconductor in a power regulator device.

A further application of the novel material of the current invention is the use of a Zn-(II)-III-N or Zn-III-N compound semiconductor in a light detecting device.

A further application of the novel material of the current invention is the use of an Zn-(II)-III-N or Zn-III-N compound semiconductor to provide large area illumination panels which are excited by a light source such as a light emitting diode or laser diode.

A further application of the novel material of the current invention is the use of an Zn-(II)-III-N or Zn-III-N compound semiconductor to provide fluorescent fibres, rods, wires and other shapes.

A further application of the novel material of the current invention is the use of an electrical current to generate the excited state which decays with the emission of light to make a light emitting diode with direct electrical injection into the Zn-(II)-III-N , or Zn-III-N semiconductor compound.

A further application of the novel material of the current invention is the use of a Zn-(II)-III-N or Zn-III-N compound semiconductor as part of the back light used in a liquid crystal display.

A further application of the novel material of the current invention is the use of a Zn-(II)-III-N or Zn-III-N compound semiconductor as the emissive species in a display such as a plasma display panel, a field emission display or a cathode ray tube.

A further application of the novel material of the current invention is the use of a Zn-(II)-III-N or Zn-III-N compound as the emissive species in an organic light emitting diode.

A further application of the novel material of the current invention is the use of a Zn-(II)-III-N or Zn-III-N compound semiconductor as the emissive species in a solar concentrator, where the light emitted by the solar concentrator is matched to a solar cell used to convert the collected light to an electrical current. More than one such concentrator may be stacked on one another to provide light at a series of wavelengths each matched to a separate solar cell.

A further application of the novel material of the current invention is the use of a Zn-(II)-III-N or Zn-III-N compound semiconductor as the light harvesting species in an organic solar cell or photo detector.

A further application of the novel material of the current invention is the use of a Zn-(II)-III-N or Zn-III-N compound semiconductor as the light harvesting species in a dye sensitised solar cell or photo detector.

A further application of the novel material of the current invention is the use of a Zn-(II)-III-N or Zn-III-N compound to generate multiple excitons from the absorption of a single photon though the process of multiple exciton generation in a solar cell or photo detector.

A further application of the novel material of the current invention is the use of a Zn-(II)-III-N or Zn-III-N compound semiconductor to assist identification in combat.

A further application of the novel material of the current invention is the use of a Zn-(II)-III-N or Zn-III-N compound semiconductor to assist in asset tracking and marking.

A further application of nanocrystals of this invention is the use of a Zn-(II)-III-N or Zn-III-N compound semiconductor as counterfeit inks.

A further application of the novel material of the current invention is the use of a Zn-(II)-III-N or Zn-III-N compound semiconductor as bio markers both in-vivo and in-vitro.

A further application of the novel material of the current invention is the use of a Zn-(II)-III-N or Zn-III-N compound semiconductor in photodynamic therapy.

A further application of the novel material of the current invention is the use of a Zn-(II)-III-N or Zn-III-N compound semiconductor as bio markers in for example cancer diagnosis, flow cytometry and immunoassays.

A further application of the novel material of the current invention is the use of a Zn-(II)-III-N or Zn-III-N compound semiconductor in flash memory.

A further application of the novel material of the current invention is the use of a Zn-(II)-III-N or Zn-III-N compound semiconductor in quantum computing.

A further application of the novel material of the current invention is the use of a Zn-(II)-III-N or Zn-III-N compound semiconductor in dynamic holography.

A further application of the novel material of the current invention is the use of a Zn-(II)-III-N or Zn-III-N compound semiconductor in a thermoelectric device.

A further application of the novel material of this invention is the use of a Zn-(II)-III-N or Zn-III-N compound semiconductor in a device used in telecommunications.

A further application of the novel material of this invention is the use of a Zn-(II)-III-N or Zn-III-N compound semiconductor for any application.

### EXAMPLES

In the following examples, several methods of fabricating a Zn-(II)-III-N or Zn-III-N semiconductor compound of the present invention are described. The examples do not however describe all possible ways in which a Zn-(II)-III-N or Zn-III-N semiconductor compound may be formed, and other methods of forming a Zn-(II)-III-N or Zn-III-N semiconductor include, but are not limited to: metal organic vapour phase epitaxy (MOVPE), chemical vapour deposition (CVD), sputtering, plasma assisted vacuum deposition, solution chemistry synthesis, pulsed laser deposition (PLD), hydride vapour phase epitaxy (HYPE), sublimation, thermal decomposition and condensation, annealing, powder or metal nitridation, and spray deposition of nanoparticles.

Photoluminescence quantum yield (PLQY) measurements are carried out using the procedure described in Analytical Chemistry, Vol. 81, No. 15, 2009, 6285-6294. Dilute samples of the nitride nanocrystals in cyclohexane with absorbance between 0.04 and 0.1 are used. Nile red PLQY 70% (Analytical Biochemistry, Vol. 167, 1987, 228-234) in 1,4-dioxane was used as a reference standard.

It should understood that the examples are given by way of illustration only, and that the invention is not limited to the examples. For example, although Examples 1 to 5 use a carboxylate, in particular a stearate, as the source of zinc the invention is not limited to this and other precursors of zinc may be used, such as, for example, amines, acetoacetonates, sulfonates, phosphonates, thiocarbamates or thiolates. Moreover, although Examples 1 to 5 use 1-octadecene or dipheyl ether as a solvent the invention is not limited to these particular solvents.

The methods described below have been found effective to obtain nanoparticles having three dimensions of the order of 1 to 100 nm, or having three dimensions of the order of 1 to 30 nm. The size of the obtained nanoparticles may be determined in any suitable way such as, for example, taking a Transmission Electron Micrograph (TEM) image of the nanoparticles and estimating the size of the nanoparticles from the TEM image.

### Example 1

### Colloidal II-III-V (ZnGaN) Compound Semiconductor Nanocrystals Sample

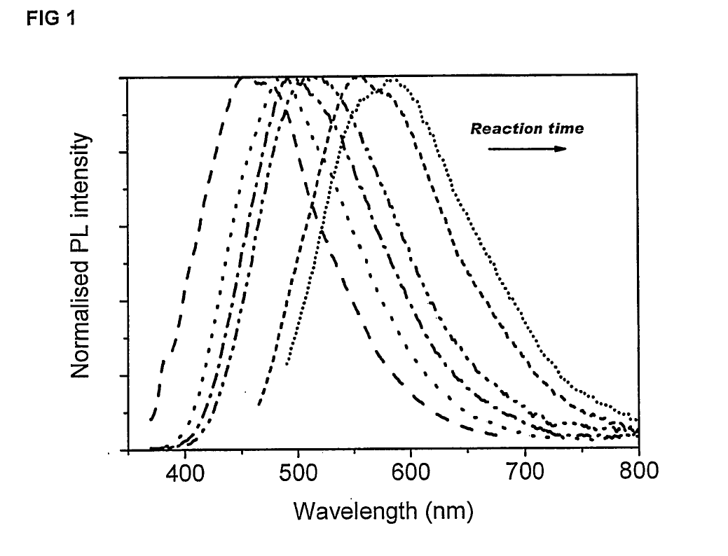

Gallium iodide (270 mg, 0.6 mmol), sodium amide (500 mg, 12.8 mmol), hexadecane thiol (308 μl, 1.0 mmol), zinc stearate (379 mg, 0.6 mmol) and 1-octadecene (20 ml) were heated rapidly to 250° C. and maintained at 250C. Of the reaction constituents, gallium iodide provided a Group III metal (Gallium), sodium amide provided the Group V atoms (Nitrogen), hexadecane thiol is a capping agent with an electron-donating group, zinc stearate provided a Group II metal (Zinc) and 1-octadecene acts as a solvent. Over the course of 60 minutes a number of 0.25 ml portions of the reaction mixture were removed and diluted with toluene (3 ml) and any insoluble materials were removed using a centrifuge. The resulting clear solutions were analysed by emission spectroscopy and showed a change in the peak emission wavelength from 450-600 nm over the course of the reaction, as shown in FIG. 1. The peak in the emission spectrum has a full width at half the maximum intensity of the order of 100 nm.

The resultant ZnGaN nanoparticles were found to have a Ga:Zn ratio of approximately 1:1.3.

When samples from such a reaction are illuminated with a UV light sources, the resultant emission is easily visible with the naked eye for samples emitting in the visible region. This illustrates the high quantum yield of ZnGaN obtainable by the present invention.

The corresponding emission spectra of these samples are shown in FIG. 1. The lefthand-most emission spectrum (shown as a dashed line) was obtained for a sample of the reaction mixture removed a few minutes after the start of the reaction, in this example 10 minutes after the start of the reaction. The righthand-most emission spectrum (shown as a dotted line) was obtained for a sample of the reaction mixture removed approximately one hour after the start of the reaction. The emission spectra between the lefthand-most emission spectrum and the righthand-most emission spectrum were obtained for samples of the reaction mixture removed at intermediate times.

It should be noted that the peak wavelength of the emission spectrum does not change uniformly with time. Initially the peak emission wavelength increases rapidly with time, but as the reaction proceeds the rate of increase, with time, of the peak emission wavelength falls.

As can be seen from FIG. 1, the emission spectra of samples removed at times up to about one hour span much of the visible region from blue to orange-red. The photoluminescence quantum yield of a sample removed from this reaction was measured and gave a value of greater than 30%.

Using the same synthesis procedure, several other ZnGaN compounds in the form of nanocrystals were made. For example:

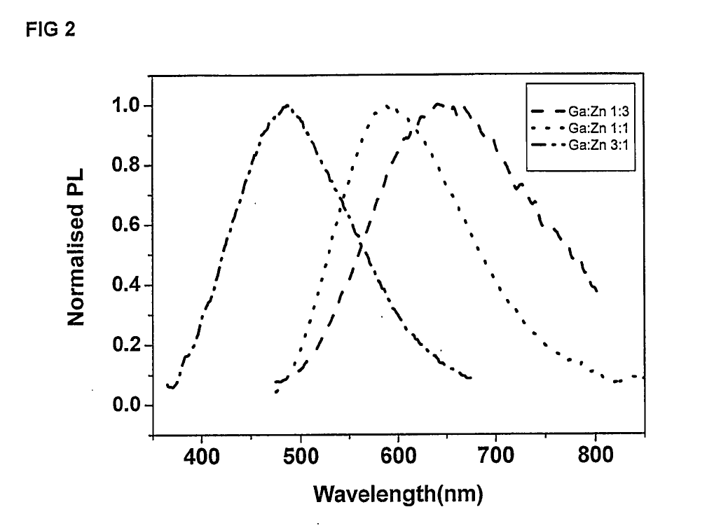

The ratio of gallium iodide to zinc stearate was varied in order to produce compounds of zinc gallium nitride containing different amounts of gallium and zinc. FIG. 2 shows the PL spectra from samples made with different zinc to gallium ratios. The emission spectra for nanoparticles with a Ga:Zn ratio of 3:1 was obtained for a sample of the reaction mixture removed approximately 90 minutes after the start of the reaction, and the emission spectrum for nanoparticles with a Ga:Zn ratio of 1:1 was also obtained for a sample of the reaction mixture removed approximately 90 minutes after the start of the reaction. The emission spectra for nanoparticles with a Ga:Zn ratio of 1:3 was obtained for a sample of the reaction mixture removed approximately 20 minutes after the start of the reaction. Thus, the emission spectra of samples removed at times up to about 90 minutes were found to span the ultraviolet-visible-infrared regions. This result demonstrates that ZnGaN having particular optical properties (such as a desired peak emission wavelength) can be obtained by the appropriate choice of quantities of zinc and gallium in the synthesis reaction.

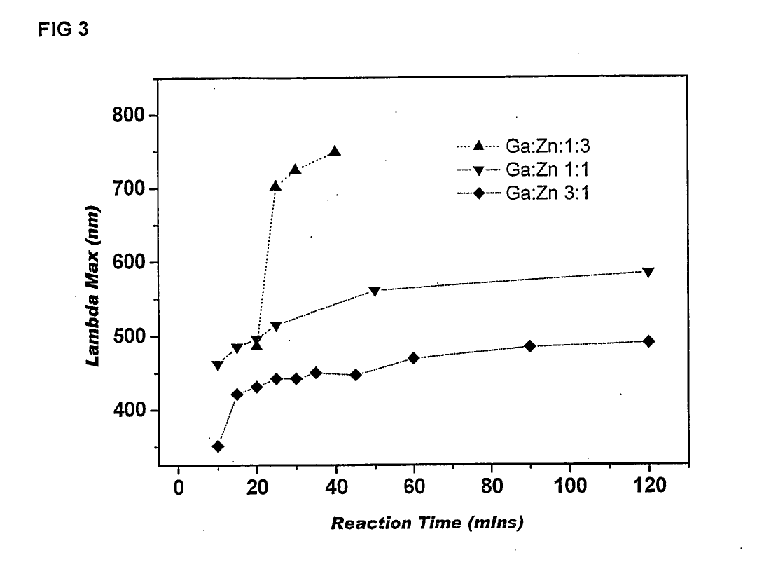

FIG. 3 shows the variation in the peak PL emission wavelengths of ZnGaN nanocrystals obtained for different reaction times and using three different zinc to gallium ratios. This result demonstrates that nanocrystals having particular optical properties (such as a desired peak emission wavelength) can be obtained by appropriate choice of the reaction period before the nanocrystals are recovered from the solution, and from the appropriate choice of quantities of zinc and gallium in the synthesis reaction. Thus, as an example, a person wishing to fabricate nanoparticles having a peak emission wavelength of approximately 450 nm (in the blue region of the spectrum) may see from FIG. 3 that this made be done by fabricating ZnGaN nanoparticles as described in Example 1, by choosing the quantities of the constituents such that the nanoparticles have a Ga:Zn ratio of 3:1, and removing the sample from the reaction about 35 minutes after the start of the reaction.

For a ZnGaN sample made with a Ga:Zn ratio in the reaction constituents of 4:1 a photoluminescence quantum yield value of 45% was obtained.

It can therefore be seen that the present invention makes possible the formation of zinc gallium nitride or more generally, the formation of the Zn-(II)-III-N compound semiconductor family, which have extremely good light-emissive properties.

It has been found that the use of zinc carboxylate, for example zinc stearate, as a starting material to act as the zinc precursor (that is, to provide the zinc) assists in obtaining a light-emissive II-III-V nanocrystal having Zn as thet/a Group II constituent that has a high PLQY.

In addition it is believed that zinc stearate helps to solubilise the amide (sodium amide in this example) in the reaction mixture to provide a more homogeneous solution which is expected to allow for more controlled growth on the nanocrystals.

As noted earlier, however, the invention is not limited to use of a carboxylate as the precursor of the Group II element, and other materials may be used as the precursor of the Group II element.

### Example 2

### Colloidal II-III-V (ZnInN) Semiconductor Nanocrystals Sample

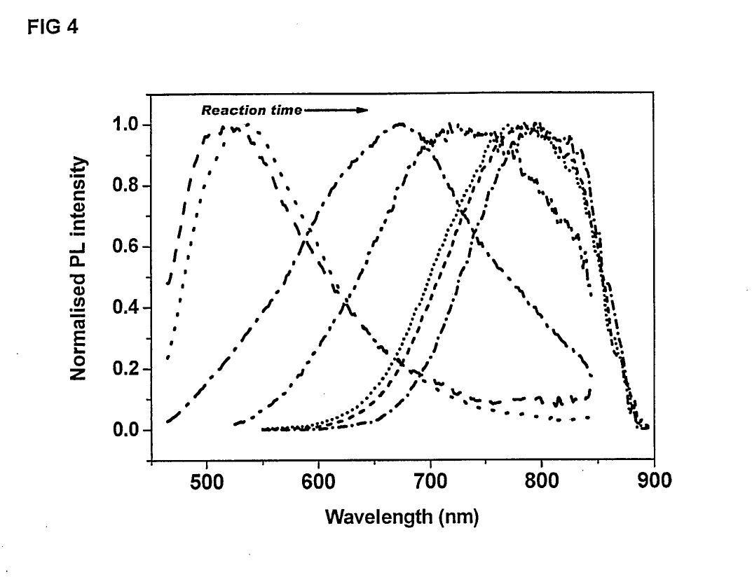

Indium iodide (300 mg, 0.6 mmol), sodium amide (500 mg, 12.8 mmol), hexadecane thiol (308 μl, 1.0 mmol), zinc stearate (379 mg, 0.6 mmol) and diphenyl ether (20 ml) were heated rapidly to 250° C. and maintained at that temperature. Of the reaction constituents, Indium iodide provided a Group III metal (indium), sodium amide provided the Group V atoms (Nitrogen), hexadecane thiol is a capping agent with an electron-donating group, zinc stearate provided a Group II metal (Zinc) and diphenyl ether acts as a solvent. Over the course of 60 minutes a number of 0.25 ml portions of the reaction mixture were removed and diluted with cyclohexane (3 ml) and any insoluble materials were removed using a centrifuge. The resulting clear solutions were analysed by PL emission spectroscopy and showed a change in the maximum emission wavelength from 500-850 nm over the course of the reaction, as shown in FIG. 4. (The lefthand-most emission spectrum in FIG. 4 was obtained for a sample of the reaction mixture removed approximately 5 minutes after the reaction started, and the other emission spectra were obtained for samples of the reaction mixture removed approximately 10 minutes, 15 minutes, 20 minutes, 25 minutes, 35 minutes and 60 minutes after the reaction started.) The peak in the emission spectrum has a full width at half the maximum intensity of the order of 100 nm.

When samples from such a reaction are illuminated with a UV light sources, the resultant emission is easily visible with the naked eye for samples emitting in the visible region. This illustrates the high quantum yield of ZnInN in the form of nanostructures obtainable by the present invention. The photoluminescence quantum yield of a sample removed from this reaction was measured and gave a value of 10%.

Using the same synthesis procedure, several other ZnInN compounds were formed. For example:

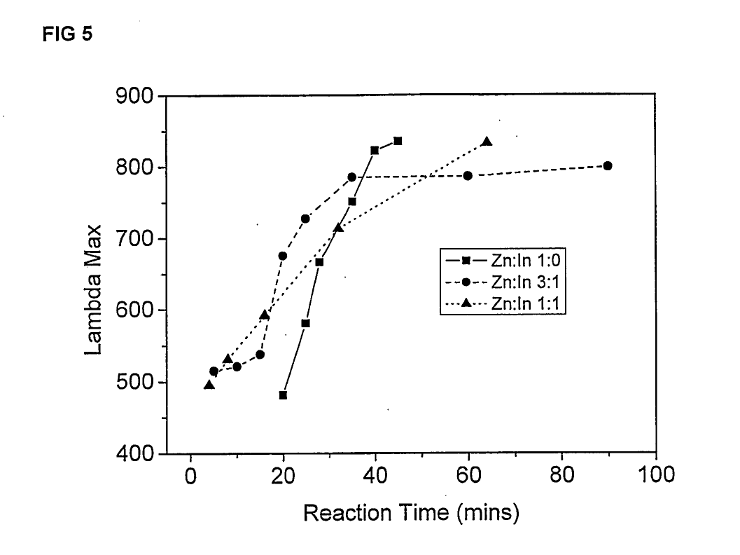

The ratio of indium iodide to zinc stearate was varied in order to produce compounds of zinc indium nitride containing different amounts of indium and zinc. FIG. 5 shows the variation in the peak PL emission wavelengths of ZnInN nanocrystals obtained for different reaction times and using different zinc to indium ratios. This result demonstrates that ZnInN having particular optical properties (such as a desired peak emission wavelength) can be obtained by the appropriate choice of quantities of zinc and indium in the synthesis reaction. For a ZnInN sample made with a In:Zn ratio of 1:4 a photoluminescence quantum yield value of 30% was obtained.

It can therefore be seen that the present invention makes possible the formation of zinc indium nitride, or more generally, the formation of the Zn-(II)-III-N compound semiconductor family, which have extremely good light-emissive properties.

### Example 3

### Colloidal II-III-V (ZnAlN) Semiconductor Nanocrystals Sample

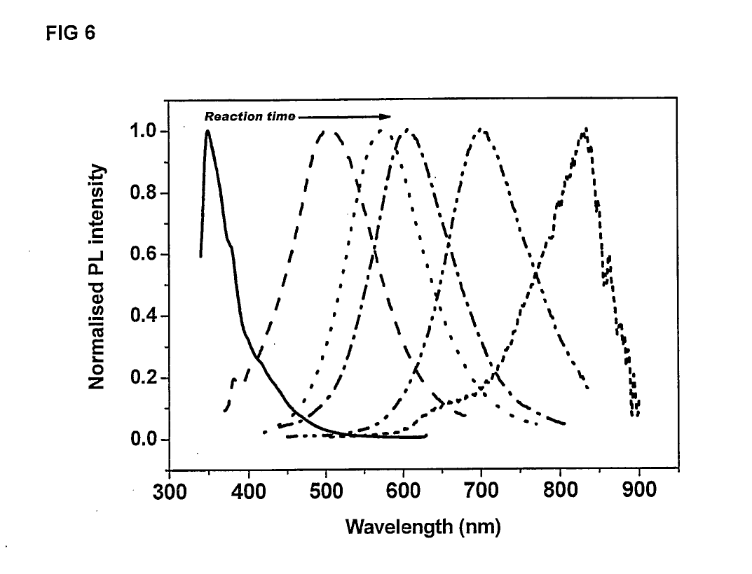

Aluminium iodide (102 mg, 0.25 mmol), sodium amide (468 mg, 12 mmol), hexadecane thiol (259 μl, 1.0 mmol), zinc stearate (474 mg, 0.75 mmol) and 1-octadecene (25 ml) were heated rapidly to 250° C. and maintained at that temperature. Of the reaction constituents, Aluminium iodide provided a Group III metal (Aluminium), sodium amide provided the Group V atoms (Nitrogen), hexadecane thiol is a capping agent with an electron-donating group, zinc stearate provided a Group II metal (Zinc) and 1-octadecene acts as a solvent. Over the course of 60 minutes a number of 0.25 ml portions of the reaction mixture were removed and diluted with toluene (3 ml) and any insoluble materials were removed using a centrifuge. The resulting clear solutions were analysed by absorption and emission spectroscopy and showed a change in the maximum emission wavelength from 420-950 nm over the course of the reaction, as shown in FIG. 6. The peak in the emission spectrum has a full width at half the maximum intensity of the order of 100 nm.

When samples from such a reaction are illuminated with a UV light sources, the resultant emission is easily visible with the naked eye for samples emitting in the visible region. This illustrates the high quantum yield of ZnAlN nanostructures obtainable by the present invention.

The corresponding emission spectra of these samples are shown in FIG. 6. The lefthand-most emission spectrum in FIG. 6 was obtained for a sample of the reaction mixture removed a few minutes after the start of the reaction, and the righthand-most emission spectrum was obtained for a sample of the reaction mixture removed approximately 60 minutes after the start of the reaction. The emission spectra between the lefthand-most emission spectrum and the righthand-most emission spectrum were obtained for samples of the reaction mixture removed at intermediate times.) The emission spectra of samples removed at times up to about one hour span the ultraviolet to visible region and extend into the infra-red. The photoluminescence quantum yield of a sample removed from this reaction was measured and gave a value of 55%.

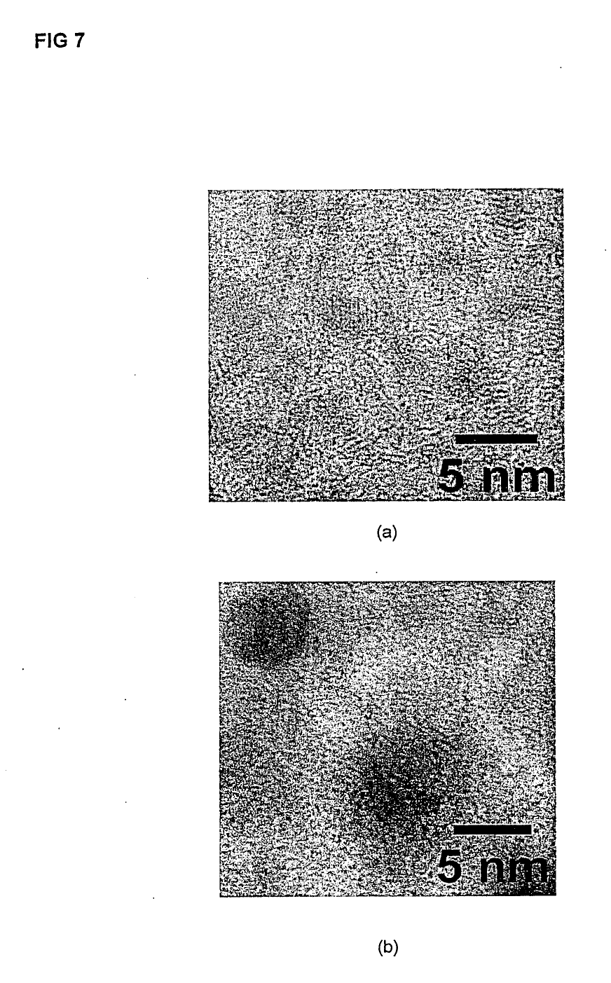

FIG. 7(a) is a Transmission Electron Micrograph of ZnAlN nanoparticles obtained by a method as described in this example. The nanoparticles have a dimension of approximately 3 nm. The image of FIG. 7(a) was obtained for a sample of the reaction mixture removed approximately 12 minutes after the start of the reaction.

FIG. 7(b) is a second Transmission Electron Micrograph of ZnAlN nanoparticles obtained by a method as described in this example. The image of FIG. 7(b) was obtained for a sample of the reaction mixture removed approximately 60 minutes after the start of the reaction. It can be seen that the nanoparticles of FIG. 7(b) have a dimension of approximately 5 nm, compared to the dimension of approximately 3 nm for the nanoparticles of FIG. 7(a).

Methods as described herein may be used to fabricate nanoparticles having dimensions of more than 5 nm, by using longer reaction times. It should however be noted that many of the applications envisaged for nanoparticles of the invention require nanoparticles that emit light in the visible region of the spectrum and, in general, this requires that the nanoparticles have dimensions of 5 nm or below—nanoparticles having dimensions of more than 5 nm will, in most cases, have a peak emission wavelength of 750 nm or greater.

Also, fabricating nanoparticles having dimensions of more than 5 nm would require the use of larger quantities of source chemicals as well as requiring longer reaction times.

It can therefore be seen that the present invention makes possible the formation of zinc aluminium nitride nanocrystals, or more generally, the formation of the Zn-III-N compound semiconductor family, which have extremely good light-emissive properties.

### Example 4

### II-III-V (ZnGaN) Semiconductor Thin Film Sample

To produce a thin film of a Zn-(II)-III-N semiconductor, a molecular beam epitaxy method was used. In particular, to produce a thin film of zinc gallium nitride the following procedure was used:
i) In a molecular beam epitaxy chamber, a gallium nitride substrate was heated to between 100° C. and 500° C. under an impinging molecular beam of plasma activated nitrogen from a radio frequency plasma cell
ii) The hot substrate was then exposed simultaneously to the molecular beam of plasma activated nitrogen and to an additional molecular beam of elemental zinc metal to form a thin film layer of zinc nitride (this step is optional and may be omitted).
iii) The hot substrate was then exposed simultaneously to the molecular beam of plasma activated nitrogen, to the molecular beam of elemental zinc metal and to an additional molecular beam of elemental gallium metal to form a thin film layer of zinc gallium nitride.
iv) The substrate was cooled down under a molecular beam of plasma activated nitrogen.

Step (ii) of forming the thin layer of zinc nitride is optional, and may be omitted.

To produce a thin film of zinc indium nitride, the elemental gallium metal is replaced by elemental indium metal in step iii).

To produce a thin film of zinc aluminium nitride, the elemental gallium metal is replaced by elemental aluminium metal in step iii).

To produce a thin film of zinc indium gallium nitride, elemental zinc, indium and gallium are supplied in step iii).

To produce a thin film of zinc aluminium gallium nitride, elemental zinc, aluminium and gallium are supplied in step iii).

To produce a thin film of zinc aluminium indium nitride, elemental zinc, aluminium and indium are supplied in step iii).

To produce a thin film of zinc aluminium gallium indium nitride, elemental zinc, aluminium, gallium and indium are supplied in step iii).

Multiple thin films of Zn-(II)-III-N semiconductor materials may be used to make different types of optoelectronic and electronic devices such as light emitting diodes, solar cells, laser diodes and transistors.

The examples described above relate to the formation of Zn-III-N materials, but similar methods may be used to obtain Zn-II-III-N materials. For example, ZnMgInN nanocrystals may be fabricated by a method similar to that described in example 2, by using both magnesium stearate and zinc stearate as starting materials.

It should be noted that methods similar to those described above may be used to form other II-III-V materials. For example, MgInN nanocrystals may be fabricated by a method similar to that described in example 2, except that magnesium stearate is used as a starting material instead of zinc stearate. As a further example, ZnGaP nanocrystals may be fabricated by a method similar to that described in example 1, except that sodium amide is replaced by a source of phosphorus atoms, for example Sodium Phosphide (Na₃P). Another possible source of phosphorus is tris(trimethylsilyl)phosphine.

1. A semiconductor material having the general formula II-III-N, where II denotes one or more elements in Group II of the periodic table, III denotes one or more elements in Group III of the periodic table, and N denotes nitrogen; wherein the one or more elements in Group II of the periodic table comprise zinc (Zn).

2. A semiconductor material as claimed in claim 1 and containing at least 1% by volume of Zn.

3. A semiconductor material as claimed in claim 1 and comprising ZnGaN.

4. A semiconductor material as claimed in claim 1 and comprising ZnInN.

5. A semiconductor material as claimed in claim 1 and comprising ZnAlN.

6. . A semiconductor material as claimed in claim 1 and comprising ZnGaInN.

7. A semiconductor material as claimed in claim 1 and having a single crystal structure.

8. A semiconductor material as claimed in claim 1 and having a polycrystalline structure.

9. A semiconductor material as claimed in claim 1 and having an amorphous structure.

10. A semiconductor material as claimed in claim 1, wherein the material is light-emissive.

11. A semiconductor material as claimed in claim 1, and further comprising at least one dopant material.

12. A semiconductor material as claimed in claim 11 and comprising one or more dopants selected from the group of: silicon, magnesium, carbon, beryllium, calcium, germanium, tin and lead.

13. A semiconductor nanoparticle comprising a semiconductor material as defined in claim 1.

14. A semiconductor thin film comprising a semiconductor material as defined in claim 1.

15. A method of making a semiconductor material composed of a group II-III-V compound, the method comprising reacting at least a source of zinc, at least one source of a source of a group III element, and a source of nitrogen.

16. A method as claimed in claim 15 and comprising reacting the source of zinc, the at least one source of a source of a group III element, and the source of nitrogen in a solvent.

17. A method as claimed in claim 15 wherein the source of zinc comprises a zinc carboxylate.

18. A method as claimed in claim 15 wherein the source of nitrogen comprises an amide.
